(19) United States
(12) Patent Application Publication
(10) Pub. No.: US 2010/0214725 A1
(43) Pub. Date: Aug. 26, 2010

(54) PARALLEL PRINTED WIRING BOARD FOR LAMP ELECTRONIC ASSEMBLY AND BRACKET THEREFOR

(75) Inventors: Jeffrey Glenn Felty, Elyria, OH (US); Magda Valerian, Willoughby Hills, OH (US); Radhika Dixit, Westlake, OH (US); Edward John Thomas, Streetsboro, OH (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/391,370

(22) Filed: Feb. 24, 2009

(51) Int. Cl. H02B 1/26

(52) U.S. Cl. 361/674

(57) ABSTRACT

A ballast assembly for a lamp includes a housing that receives a circuit board assembly therein. The circuit board assembly preferably has first and second board portions disposed in physically spaced, parallel relation. The board portions are interconnected by a conductive member, preferably a flexible conductive member. The spacing between the board portions is preferably substantially identical to a maximum height dimension of a tallest electrical component extending outwardly from one of the first and second board portions. A separate mounting bracket mechanically secures the housing to an associated surface and constrains the housing along at least one of first, second, and third perpendicular axes. Preferably, the mounting bracket is a one-piece construction where first and second ends of the bracket are laterally off-set, and the bracket can also serve as a heat sink to the ballast housing.

### BACKGROUND OF THE DISCLOSURE

This disclosure relates to lighting assemblies, and more particularly to mini-ballast designs such as used with high intensity discharge lighting arrangements. It may find application, however, in related lighting applications.

Fixture manufacturers are requiring smaller and more compact ballasts for their designs and requesting that the size reduction be achieved without any attendant loss of performance or features. For example, in the operating range of twenty (20) watt and thirty-nine (39) watt ballast designs, known prior art arrangements have attempted to resolve this issue by splitting or dividing a printed circuit board design into two or more boards that are arranged or mounted perpendicular to one another. This has resulted in an increase in surface area for electrical components as a result of the perpendicular mounting arrangement. Further attempts have tried to resolve the issue by reducing component size or changing the topologies of the printed circuit boards. However, known arrangements have generally resulted in less efficient ballasts. It appears that these designs do not adequately address at least some of the following issues.

The different components comprising the ballast design were not efficiently located on one of the two board portions. Boards were rigidly connected in a substantially perpendicular conformation with contiguous edges joined by mechanical connections.

Little or no consideration was given to electromagnetic interference (EMI) issues, the number of connections between boards was not limited, and thermal benefits were inadequately addressed. Instead, the focus of prior designs related to dimensional constraints, which admittedly were improved over earlier designs, but still did not adequately handle all of these issues. One board portion was typically larger than another. This resulted in waste during manufacture, and a less efficient dimensional design. A number of connections were also provided between the board portions, but since high frequency components were mounted on each of the board portions, this necessarily required the connections to carry high frequency signals between the board portions. The high frequency signals contributed to EMI concerns.

In addition, thermal considerations were not effectively handled in prior art designs. Careful management of the thermal issues could result in cooler operating temperatures which, in turn, result in possible use of a higher wattage design used in a similar sized housing. Alternatively, there is a correlation between reduced operating temperature and increased expected life of the ballast.

Still another drawback in prior designs is the physical mounting of the ballast housing within the fixture. In some designs, mounting features are integrally provided in the housing which unnecessarily adds to the overall size of the housing, and does not provide for design flexibility for the fixture manufacturers. Protection of input lines or lead wires that provide the required electrical power to the ballast, from the power source through the housing to the electronics, are often overlooked in designs. As will be appreciated, potential shorting of the lead wire in an HID application, for example, is a big concern.

Again, prior designs have not gone far enough in their design analysis to adequately consider thermal applications, improve EMI protection, and ease of use/installation. Consequently, a need exists for an improved ballast design and associated mounting arrangement for a ballast housing.

### SUMMARY OF THE DISCLOSURE

A ballast assembly for a lamp includes a housing that forms an internal cavity and receives a circuit board assembly therein. The circuit board assembly includes first and second board portions having substantially the same planar dimensional footprint and disposed in physically spaced, non-contiguous relation and interconnected by at least one conductive member.

The at least one conductive member is preferably a flexible jumper.

The first and second board portions are preferably disposed in substantially parallel relation.

In the preferred parallel mounting arrangement of the board portions, electrical components preferably extend outwardly from facing surfaces of the parallel boards and are arranged so that the components are mated and interleaved to minimize the dimensional spacing between the parallel board portions.

The first and second board portions are spaced apart by a spacing dimension that closely approximates and is no less than a maximum height dimension of a tallest electrical component extending outwardly from one of the first and second board portions.

One of the first and second board portions does not receive any high frequency components in a preferred arrangement.

Perimeter dimensions of the first and second board portions are substantially the same as a cross-sectional dimension of the housing cavity, and moreover, the first and second board portions are substantially identical in perimeter size.

A separate mounting bracket is dimensioned for receipt over the ballast housing and mechanically secures the housing to an associated surface while constraining the housing along at least first, second, and third faces of the housing.

In a preferred arrangement, first and second ends of the bracket are laterally off-set from one another.

In the preferred lateral off-set end arrangement, the bracket ends are maximally displaced and oriented relative to the input lines.

In a preferred arrangement, the mounting bracket is a one-piece construction.

A primary advantage of the present disclosure is the compact arrangement of the ballast.

Another advantage relates to improved EMI and reduced radiant noise by minimizing loops and transmission of high frequency signals through connections joining the board portions.

Yet another benefit resides in the minimized number of connections between the board portions, minimizing waste in manufacture of the board portions, and using the component as the primary dimensional constraint of the ballast assembly.

Still another benefit is associated with maximizing the distance between the input/outlet lines or wires and the mounting bracket.

A still further benefit is associated with an overall increase in the power density of the finished product.

Still other benefits and advantages of the present disclosure will become apparent from reading and understanding the following detailed description.

### BRIEF DESCRIPTION OF THE DRAWINGS

FIG. 1 is a perspective view of a housing enclosing a ballast and a separate mounting bracket.

FIG. 2 is a plan view of a panel (the backside or solder side) that has multiple printed circuit boards divided into halves.

FIG. 3 is a plan view of the panel (the top side) and printed circuit boards of FIG. 2.

FIG. 4 shows the mounting of components, connectors/jumpers, and the input/outlet wires on a first surface or top side of the printed circuit board.

FIG. 5 is an enlarged view of the board portions after separation from the panel.

FIG. 6 is a front elevational view of the board portions disposed in close fitting, parallel relation.

FIG. 7 is a rear elevational view of the parallel board portions of FIG. 6.

FIG. 8 is an end elevational view of the parallel board portions of FIG. 6 received in a ballast housing.

FIG. 9 is a perspective view of a preferred mounting bracket, particularly of the type illustrated in FIG. 1.

FIGS. 10-13 are perspective views of alternative mounting brackets.

FIG. 14 is a schematic representation of an alternative bracket design.

FIG. 15 illustrates the bracket of FIG. 14 mounted on the ballast housing.

### DETAILED DESCRIPTION OF THE PREFERRED EMBODIMENTS

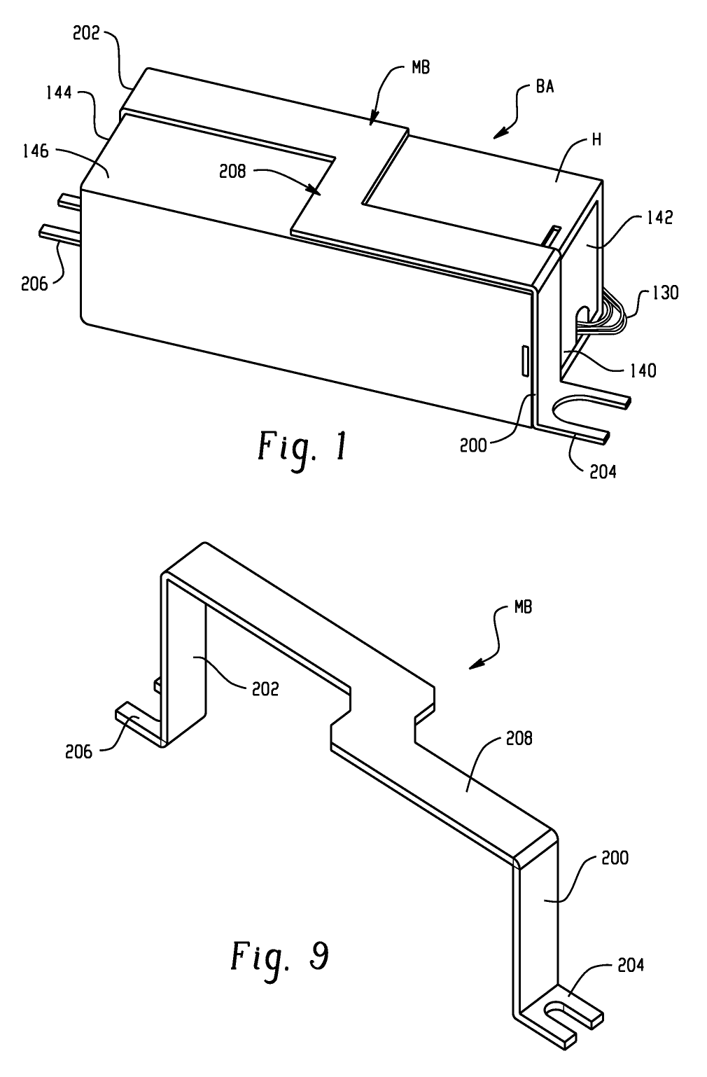

FIG. 1 illustrates a ballast assembly BA that includes a housing H shown in one preferred form as an elongated parallelepiped structure that encloses a circuit board assembly (to be described further below), and a separate mounting bracket MB.

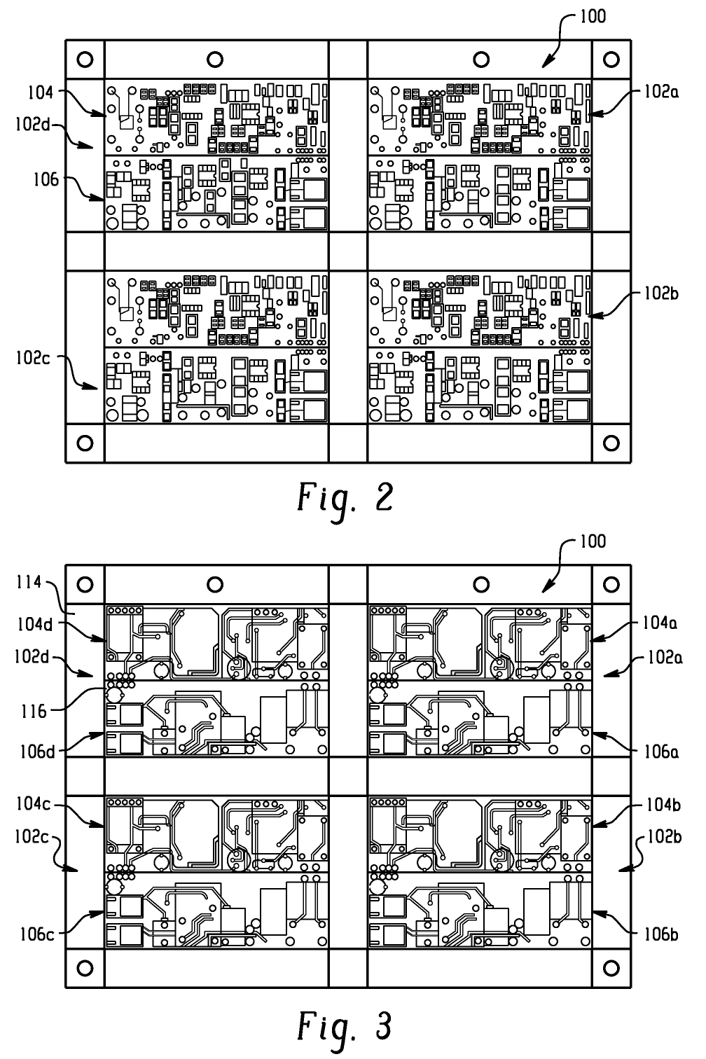

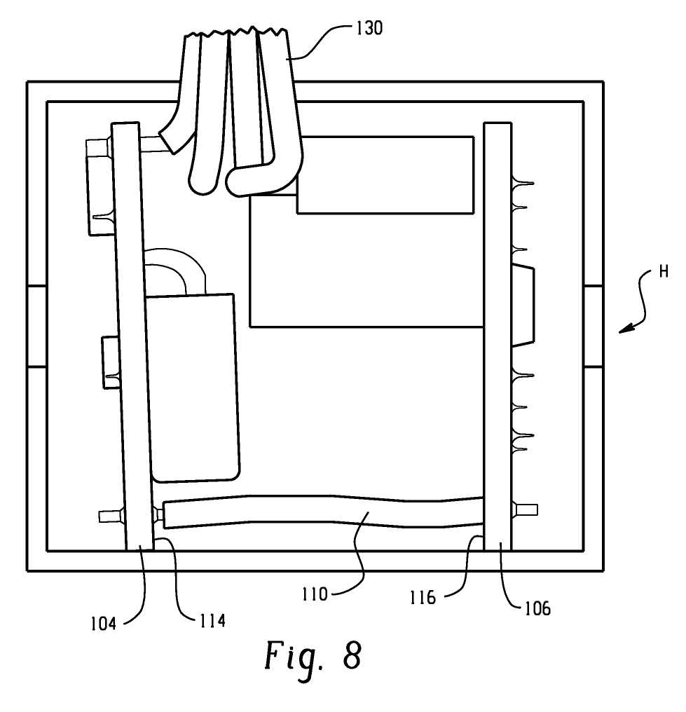

With continued reference to FIG. 1, and additional reference to FIGS. 2-8, selected features of the ballast assembly BA will be described in greater detail. FIG. 2 shows one side of a panel 100 in which predetermined electrical traces, through holes, etc. are formed in a well known manner and adapted to receive various electrical components to form a printed circuit board assembly. In this particular instance, the panel 100 has a rectangular conformation that is dimensioned to form four (4) separate boards 102a-102d, each printed circuit board 102 including first and second board portions 104a-104d, 106a-106d that are physically formed and connected together in the panel. Each of the board portions 104, 106 has a generally rectangular conformation, although this need not necessarily be the case. However it is desirable that the board portions be designed to operate in conjunction with one another to together define a printed circuit board or circuit board assembly 102 that serves as a ballast to an associated lamp (not shown). By designing the board portions 104, 106 to work in concert, the required surface area of a printed circuit board 102 can be efficiently used, and likewise dimensioned to fit within the housing H in a manner to be described below.

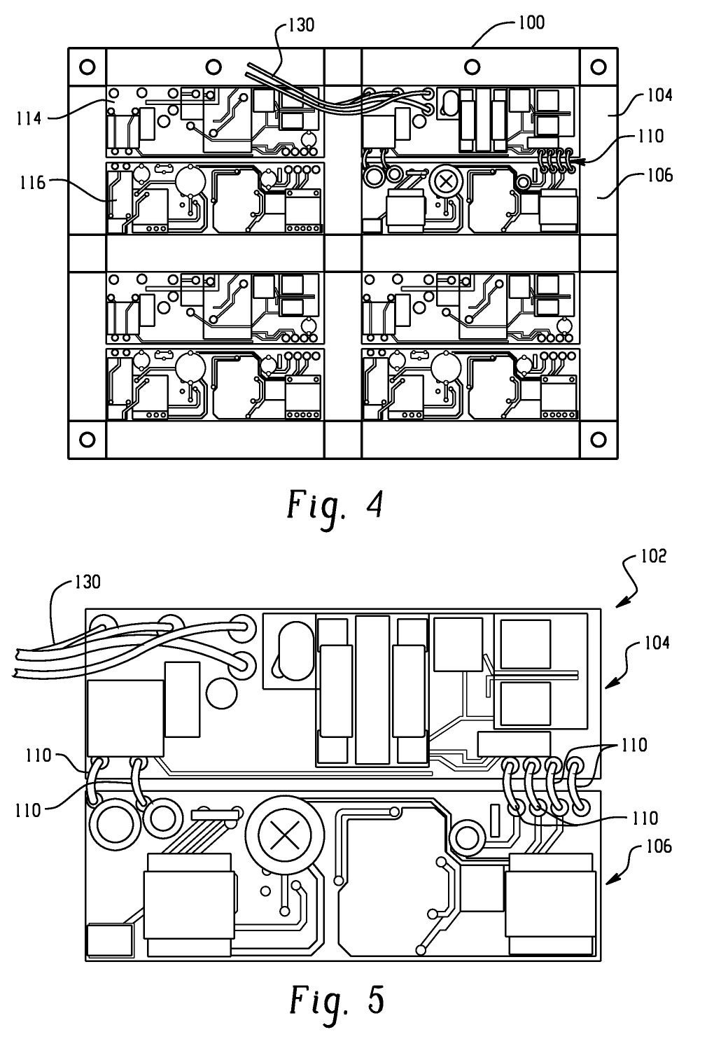

As will be appreciated, the particulars of the circuit board design may vary from one lamp to another, or for that matter different circuits and circuit designs can be used to operate the associated lamp. Thus, the particulars of the circuit are not deemed to be of particular importance. On the other hand, careful consideration is provided to location or placement of selective electrical components on the board portions 104, 106 associated with the circuit board design. In this particular arrangement, a three stage circuit design is used where each stage is a bit more efficient than the next, i.e., there are three incremental stage efficiencies. A primary consideration is separating low frequency components (for example, less than or equal to 400 Hz) from high frequency components (for example, greater than 400 Hz) between the first and second board portions 104, 106, respectively. It will be appreciated that the threshold level between low and high frequency components may differ from one design to another. However, the segregation of the low frequency components from the high frequency components is desirable for reasons to be described further below. The first and second board portions 104, 106 are physically interconnected (i.e., a part of the panel) in FIGS. 2, 3, and 4, although in FIG. 5 the circuit board portions have been separated from the remainder of the panel, cut to size and separated from one another, and remain mechanically and electrically interconnected by one or more conductive members 110. In this particular instance, the conductive member that interconnects the otherwise separated board portions includes six (6) flexible conductive members or wires 110. A flexible insulated wire mechanically interconnects the first and second board portions, and electrically joins the first and second board portions as shown in FIG. 4 before the board portions are separated from the panel as illustrated in FIG. 5. In other words, once the board portions 104, 106 have been separated from the remainder of the panel 100, the flexible conductive members 110 mechanically and electrically interconnect the first and second board portions 104, 106.

As evident by comparing FIG. 3 with FIG. 4, selected electrical components are mounted onto first faces (topside) 114, 116 of the first and second board portions 104, 106, respectively, and extend outwardly from these first surfaces. Particularly, each of these components includes electrical leads that extend through through-holes provided at predetermined locations on the circuit board portions. For example, and without limiting the subject application, these components may include transformers, filters, capacitors, etc., it being understood that this list is not intended to be exhaustive. Once the electrical leads of the components are received through the through-holes, the leads are soldered or otherwise electrically connected with the circuit in the multi-layer circuit board arrangement in a manner well known in the art. The components are separated into low frequency and high frequency components that are located on the first and second board portions 104, 106, respectively. As a part of EMI management associated with the preferred embodiment, it is desirable that the low frequency components, i.e., those components below a certain threshold frequency (e.g., 400 Hz) be maintained on one board portion 104 while the high frequency components be maintained on another board portion 106. Since the board portions are electrically (and ultimately mechanically) connected via the lead wires 110, it is preferred that those circuit portions associated with the low frequency arrangement be segregated so that high frequencies do not pass through the flexible conductive wires 110. This limits the development of magnetic fields otherwise associated with passing high frequency current through the conductive members/wires.

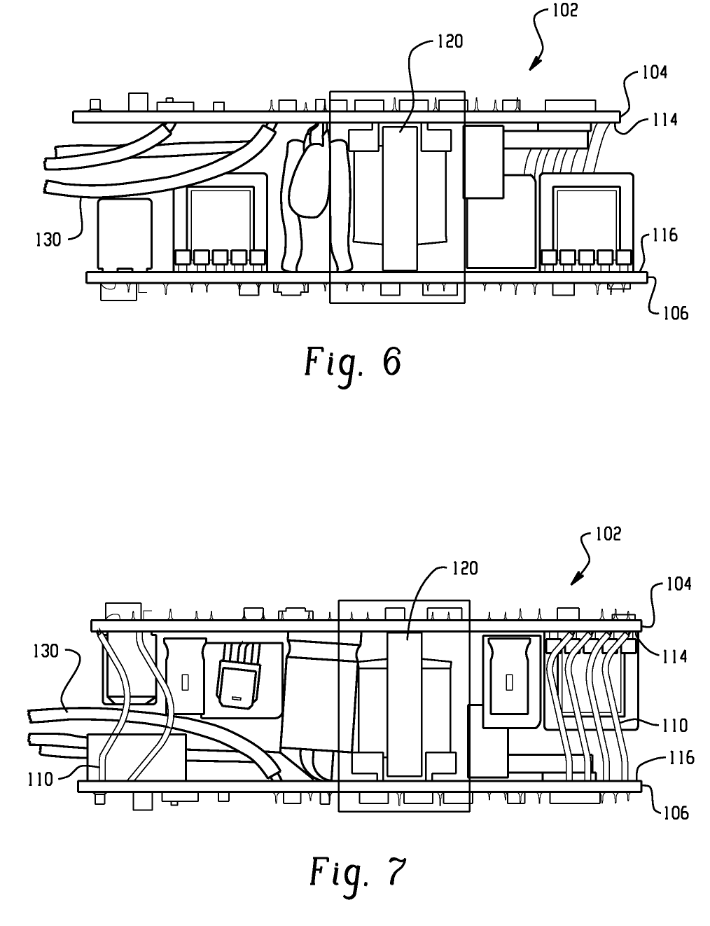

Another important consideration that is partially evident in FIG. 5, and more apparent in FIGS. 6-8, is that the taller electrical components are secured to the board portions 104, 106 in a manner that provides for mating, interleaving, compact fitting of the board portions together. That is, a magnetic component 120 is shown to be the tallest component in this particular circuit board assembly 102. The magnetic component 120 has a height above (extends outwardly from) the surface 114 that is greater than the remaining electrical components mounted on either the first or second board portion 104, 106. This height dimension preferably defines the dimensional spacing between the parallel board portions.

Once the board portions are separated from the panel 100, the board portions are hinged or bent around the flexible lead wires 110 in a manner to position the board portions in parallel, overlying relation. The peripheries of the individual board portions 104, 106 are substantially aligned one above the other as shown in FIGS. 6-8, and as noted above the magnetic component further defines the preferred dimensional spacing between the parallel board portions. Other electrical components having a reduced height are located to extend from the respective board portions so as to fit one atop another or to be interleaved between one another in a compact manner. Thus, the particular location of the electrical components on the board portions is preselected so as to minimize the dimensional spacing between the parallel boards when top side surfaces 114, 116 are disposed in facing relation as illustrated in FIGS. 6-8.

In addition, input/output wires 130 also preferably extend from one of the board portions, and in this particular arrangement, extend from surface 114 of the first board portion 104 as shown in FIGS. 5 and 6. However, it will be appreciated that the input/output wires 130 could extend from another surface or the other board portion if so desired. In the illustrated arrangement, all of the input/output wires 130 are situated so that they extend outwardly from one corner portion of the housing (see FIGS. 1 and 6-8), although this is not required as will be understood by one skilled in the art. A suitable opening 140 is provided in end wall 142 of the housing to receive the input/output wires therethrough.

As perhaps best evident in FIGS. 6-8, when the board portions 104, 106 are disposed in overlying relation, the outer perimeters of the first and second board portions are substantially identical in dimension, and arranged so that their respective edges lie in roughly the same plane. That is, the narrow edges are aligned in parallel planes, and the elongated edges of each of the board portions are likewise disposed in separate, parallel planes. This dimensional relationship corresponds to and is substantially the same as a cross-sectional dimension of the housing cavity. In this manner, the housing H is closely spaced relative to the aligned perimeters of the parallel board portions. In one arrangement, the housing H is a plastic housing that is closed at one end and receives the removable end wall 142 at the other end. The board portions are manipulated into the parallel relation shown in FIGS. 6 and 7, and the entire printed circuit board assembly then inserted into the open end of the housing cavity where the end member 142 then closes the housing cavity.

Prior to closing the cavity, a potting compound (not shown) is preferably introduced into the housing cavity. A portion of the potting compound can be introduced before the circuit board assembly is received in the housing cavity, and thereafter the remainder of the potting compound introduced therein. Alternatively, the circuit board assembly may be inserted into the housing and the potting compound then introduced around the circuit board assembly before closing the housing.

Radiated noise is reduced due to the minimization of loops in the structure. Likewise, since there are a reduced number or a lack of high frequency signals transmitted through the jumpers 110 between the board portions, there is also a substantial improvement in the EMI. The tighter loops reduce layout parasitic and reduce voltage overstress on key components. This is particularly advantageous with regard to semiconductor components such as field effect transistors, diodes, etc. Reduced electrical stress is also achieved as a result of improved surge protection due to adequate spacing between line and neutral throughout the printed circuit board layout. All of these features are achieved with improved printed circuit board assembly density and surface area. There is also a reduced distance between magnetic high voltage output and the next top level functional circuit block. This preferred arrangement is able to use off-the-shelf components to minimize costs, and by using the magnetic component as an integral spacer, there is no need to use a separate spacer component. If desired, a separate plastic spacer may be incorporated into the arrangement while still maintaining many of the advantageous features noted above. Manufacturing is also improved due to the limited number of connections between the two board components. That is, there are only six (6) connections between the two board portions in the illustrated embodiment. The predetermined locations of the components extending from the first and second board portions also facilitate flow of the potting material through the printed circuit board assembly.

Use of the flexible jumper wires versus the rigid integral type of connector of the prior art simplifies integrated circuit testing. During manufacture, the integrated circuit testing and field testing can be conducted on both board portions in a single test setup. This should be contrasted with a rigid connector which requires testing of the first board portion, then testing the second board portion, then connecting the board portions together, and retesting the connected board portions to ensure the board portions were not damaged after de-paneling and connecting.

Board surface area is ultimately increased and there is an associated thermal benefit that results from increasing the dimensional spacing or spreading out heat generating components from one another. This further protects the assembly against localized hot spots. The component spacing also helps to minimize loops and improves the EMI as noted above, while also improving electrical efficiency. The following table is a comparison of the present disclosure with a known thirty-nine watt (39 W) arrangement. As shown in the table, the overall outer dimensions of the finished product are substantially reduced when compared to known prior art arrangements. This leads to substantially reduced volume and results in an overall increase in the power density, on the order of approximately twenty-seven percent (27%) increased power density.

| | GE | Prior Art Design |
|---|---|---|
| Length, mm | 76 | 90 |
| Width, mm | 33 | 33 |
| Height, mm | 28 | 30 |
| Volume, mm³ | 70224 | 89100 |
| Volume, cm³ | 70.224 | 89.1 |
| Density, W/cm³ | 0.5554 | 0.4377 |
| % increase | 26.88 | |

FIGS. 1 and 9 more particularly illustrate a preferred mounting bracket used in association with the above described ballast assembly. As described previously, the inlet and outlet wires 130 are preferably situated in one corner of the housing H. As perhaps best appreciated from FIG. 1, the bracket MB is spaced from that region where the inlet/outlet wires enter and exit the housing through the end wall 142. A preferred mounting bracket MB has a generally Z-shaped conformation in which first and second legs or leg portions 200, 202 are disposed in generally parallel relation and extend over end faces 142, 144 of the housing H at opposite ends. Thus, the first and second legs 200, 202 have a height that extends substantially the same as the height of the housing. The legs terminate at one end in U-shaped recesses 204, 206 that extend substantially perpendicular to the legs 200, 202. The U-shaped recesses demonstrate one form of securing the bracket to an associated component by means of fasteners (not shown). The opposite ends of the first and second legs 200, 202 are joined by a Z-shaped, interconnecting leg 208. Preferably, the interconnecting leg 208 is symmetrical about two axes so that the first and second legs 200, 202 are situated at opposite ends, and on laterally offset corners of the housing structure. Likewise, the symmetrical relation is desirable so that if the bracket is installed in a reverse fashion (e.g., leg 200 shown on the right-hand end of FIG. 1 is disposed at the left-hand end), then the leg 200 or 202 situated at end face 142 would still be spaced a maximum dimension from the input/output wires 130. This limits the potential that sharp edges of the bracket could inadvertently cut the input/output wires.

Moreover, the bracket MB is preferably formed of a thermally conductive material so that the bracket can also act as a heat sink. The additional surface area of the bracket shown in FIG. 1, or the substantially similar bracket design of FIG. 9, provides additional surface area between the two legs 200, 202 where the interconnecting leg 208 traverses the upper surface 146 of the housing. As will be appreciated by one skilled in the art, a reduction in operating temperature corresponds to potentially improved electrical efficiency of the circuit so that the heat sink capabilities can provide further value and benefit. Moreover, the bracket is usually a metal structure so that the bracket can also act as a ground plane or shield to address and improve radiated EMI issues.

The bracket preferably engages the housing along three perpendicular surfaces (end walls 142, 144 and surface 146) so as to protect against vibration. The reduction in vibration resulting from the use of the mounting bracket MB prevents damage during shipment of the fixture with the ballast assembly mounted in place and thereby reduces return costs associated with damaged fixtures.

The symmetrical design of the bracket also provides a controlled, repeatable method of mounting that limits the potential for human error. Again, although not all embodiments need to incorporate this feature, the embodiments of FIGS. 1 and 9 illustrate the reversible mounting nature of the mounting bracket.

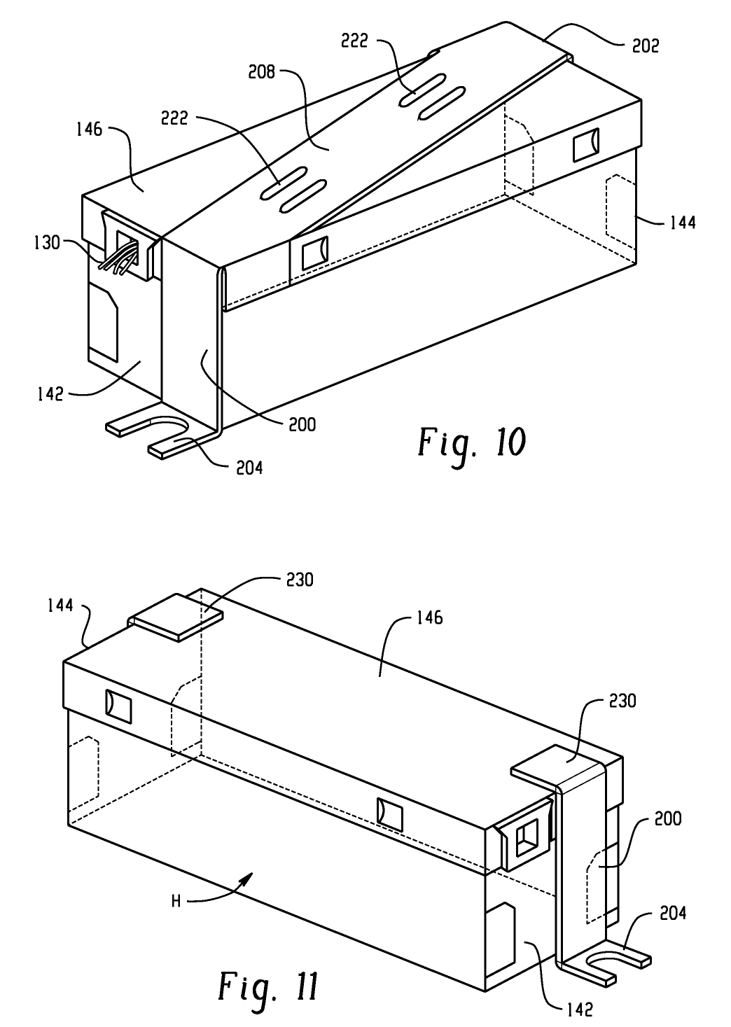

Still other mounting bracket arrangements shown in FIGS. 10-15 serve one or more of these various benefits. For example, in the embodiment of FIG. 10, two-dimensional symmetry is still provided with a linear interconnecting leg 208. This leg has also been modified to include spring detents 222 at spaced locations along the interconnecting member 208. The detents 222 provide a bowed conformation that applies a spring or urging force against the surface 146 of the housing over which the interconnecting leg extends. This further addresses the vibration issues noted above.

FIG. 11 illustrates that the bracket may comprise separate bracket portions that together act as a single bracket. The first and second legs 200, 202 are again dimensioned for receipt over respective ends 142, 144 of the housing H. Although the second ends of the legs do not include a complete connection via an interconnecting leg, segmented leg portions 230 extend partially over the surface 146 of the housing that is perpendicular to the end walls. Thus, some of the benefits are still achieved with the two or multi-piece mounting bracket arrangement of FIG. 11.

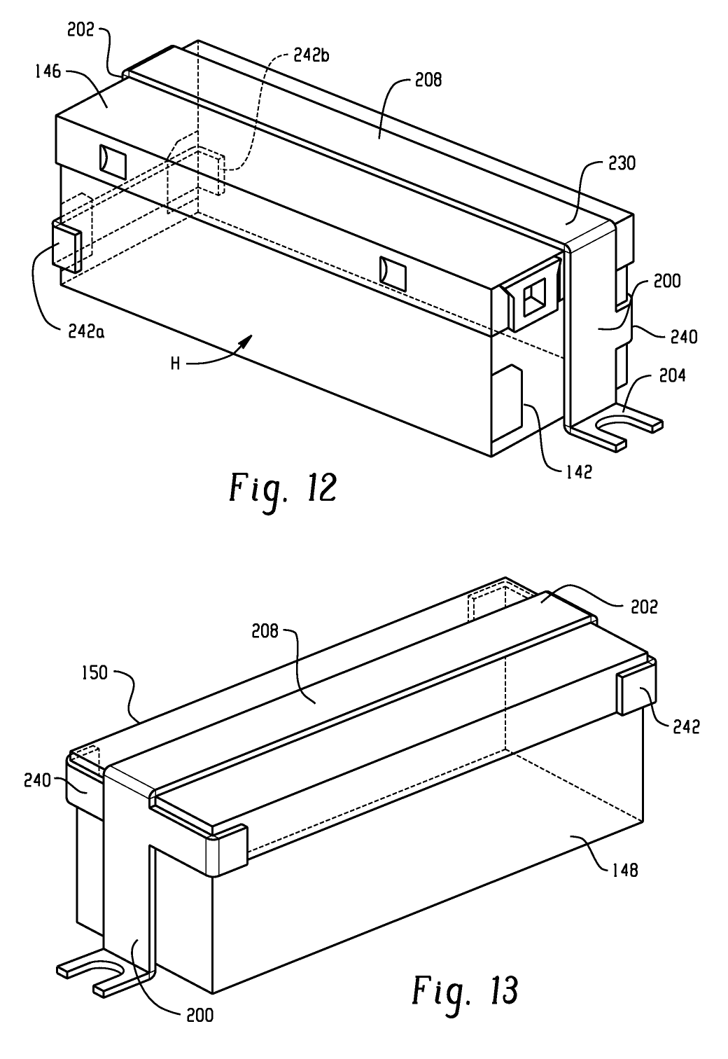

In FIG. 12 the two-dimensional symmetry is maintained and additional mechanical securing is provided. That is, the first and second legs 200, 202 are still joined by an interconnecting leg 208. However, the first and second legs are disposed along substantially the same edge of the end walls 142, 144. Additional securing is provided by the lateral arm portions 240, 242 that extend from the first and second leg portions, respectively. For example, at one end, first and second lateral arms 242a, 242b proceed over the end wall 144 and turn through ninety degrees (90°) over the sidewalls. The first leg 200, on the other hand, has only one arm 240 that proceeds through ninety degrees (90°) from the end wall to the sidewall of the housing.

In FIG. 13, the interconnecting leg 208 is more centrally positioned over the upper surface 146 while arms 240, 242 extend in lateral fashion over each of the end walls 142, 144 and partially extend over portions of sidewalls 148, 150 at each end. Again, at least some of the benefits associated with the more preferred bracket arrangement of FIGS. 1 and 9 are achieved, while others are not available, but increased mechanical securing in X, Y, and Z directions are obtained.

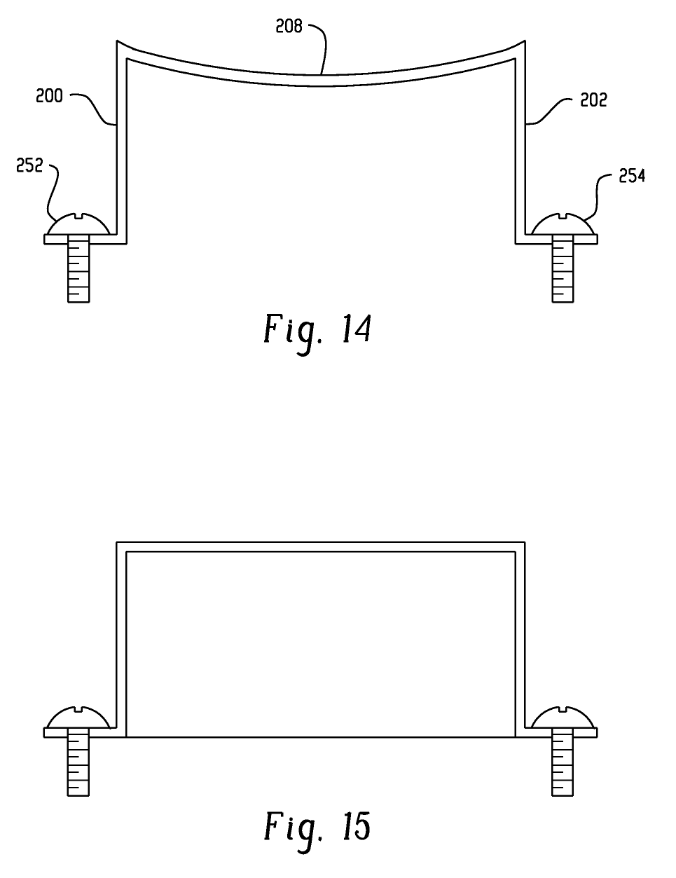

FIGS. 14 and 15 are variations on the spring force that was briefly described in association with FIG. 10. As shown in FIG. 14, the interconnecting leg 208 preferably has a predetermined inward bow and is preferably formed of a spring-like material. The material is intended to deflect outwardly from the predetermined inward bow once the legs are secured via fasteners 252, 254 to an associated mounting surface. As seen in FIG. 15, the interconnecting leg 208 adopts a planar conformation once the fasteners are secured into an associated mounting surface and the bracket tightened into securing engagement over the housing. This provides the desired urging or spring force that improves protection against potential vibration issues.

It will be appreciated that alternative shaped brackets can provide one or more of the various benefits, although the Z-shaped bracket is more preferred. The bracket can be made from a variety of materials, metallic, non-metallic, etc. There are benefits to a metallic arrangement such as the noted thermal benefits of acting as a heat sink, the EMI benefit where the grounded metal bracket can serve as a ground plane or shield, as well as the low cost associated with stamped metallic components. Thus, there is a trade-off between these various benefits. For example, a bracket that will fully encase the entire ballast housing may have improved heat sink or vibration issues, but may undesirably add to the cost. Likewise, additional costs associated with additional material relates to whether one, two, or all three directions of movement in the X, Y, and Z axes directions are addressed with a particular bracket design.

This disclosure provides sufficient spacing to mount electrical components on a printed circuit board within a given area. By mounting two printed circuit board portions in a parallel configuration, use of existing space is maximized. This also advantageously allows the use of a more efficient topology. A more efficient circuit topology in a smaller, more compact ballast is achieved while obtaining better efficiency in the same or smaller package when compared to prior art arrangements. Although other prior art arrangements have extended the length or increased the size of the ballast housing, for example by adding integral mounting feet, this limits the ability for the ballast to be used in small-space applications such as track fixtures. The non-integral mounting bracket does not require the ballast housing to be increased in size which, of course, can be important when working in tight dimensional space constraints.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A ballast assembly for a lamp comprising:
a housing enclosing an internal cavity; and
a circuit board assembly dimensioned for receipt in the housing cavity, including first and second board portions disposed in physically spaced, non-contiguous relation and interconnected by at least one conductive member.

2. The assembly of claim 1 wherein the at least one conductive member is flexible.

3. The assembly of claim 1 wherein the at least one conductive member is a conductive wire.

4. The assembly of claim 1 wherein the first and second board portions are disposed in substantially parallel relation.

5. The assembly of claim 1 wherein the first and second board portions each have electrical components that extend outwardly from a first face of each board portion.

6. The assembly of claim 5 wherein at least one electrical component extends from each board portion.

7. The assembly of claim 6 wherein the first faces of the first and second board portions are disposed in generally facing relation.

8. The assembly of claim 7 wherein the first and second board portions are spaced apart by a spacing dimension that closely approximates and is no less than a maximum height dimension of a tallest electrical component extending outwardly from one of the first and second board portions.

9. The assembly of claim 8 wherein the at least one conductive member carries current at a frequency less than approximately 400 hertz.

10. The assembly of claim 1 wherein the first board portion does not receive any high frequency components.

11. The assembly of claim 10 wherein high frequency is on the order of at least approximately 400 hertz.

12. The assembly of claim 11 wherein perimeter dimensions of the first and second board portions are substantially identical.

13. The assembly of claim 12 wherein the perimeter dimension of the first and second board portions are substantially the same as a cross-sectional dimension of the housing cavity.

14. A ballast assembly for a lamp comprising:
a polygonal housing having an internal cavity;
an electrical circuit board assembly received in the housing cavity;
wiring extending from the board assembly and through an opening in the housing; and
a separate mounting bracket dimensioned for receipt over the housing and for mechanically securing the housing to an associated surface, the mounting bracket constraining the housing along at least first, second, and third faces of the housing.

15. The ballast assembly of claim 14 wherein at least two of the first, second, and third faces are disposed in parallel relation, and the wiring exits the housing along one of the parallel faces.

16. The ballast assembly of claim 15 wherein first and second ends of the bracket are laterally offset from one another.

17. The ballast assembly of claim 14 wherein the mounting bracket contacts the housing along at least one surface to serve as a heat sink to the housing.

18. The ballast assembly of claim 14 wherein the mounting bracket is a one-piece construction.

19. The ballast assembly of claim 14 wherein the mounting bracket overlies portions of at least three distinct surfaces of the housing.
